(19) United States
(12) Patent Application Publication
(10) Pub. No.: US 2008/0080904 A1
(43) Pub. Date: Apr. 3, 2008

(54) Inner cap, developer container using the same, method for closing developer container, and method for removing inner cap

(75) Inventors: Naofumi Murayama, Niigata (JP); Kotaro Noguchi, Niigata (JP)

Correspondence Address: SUGHRUE-265550, 2100 PENNSYLVANIA AVE. NW, WASHINGTON, DC, 20037-3213, US

(73) Assignee: Fuji Xerox Co., Ltd, Tokyo (JP)

(21) Appl. No.: 11/783,520

(22) Filed: Apr. 10, 2007

(30) Foreign Application Priority Data
Sep. 29, 2006 (JP) 2006-267988

(51) Int. Cl. G03G 15/08

(52) U.S. Cl. 399/262

(57) ABSTRACT

An inner cap includes: an outer circumferential portion that has a part to be inserted and fit into an opening portion formed by being surrounded by a projection portion of a space portion; a slip-off preventing projection that is formed at a part located in a downstream side in an insertion direction of the outer circumferential portion to be caught by a projection portion provided on an inner wall of the space portion; an insertion stop projection that is formed at a part located in an upstream side in the insertion direction of the outer circumferential portion to be caught by the projection portion; and an insertion front end surface portion that includes a surface in a concave portion dented at a place located inwardly from the outer circumferential portion in a direction opposite to the insertion direction.

### CROSS-REFERENCE TO RELATED APPLICATIONS

This application is based on and claims priority under 35 U.S.C. 119 from Japanese Patent Application No. 2006-267988 filed Sep. 29, 2006.

### BACKGROUND

1. Technical Field

The present invention relates to an inner cap, a developer container using the inner cap, and a method for closing the developer container, and a method of removing the inner cap.

2. Related Art

Some image forming apparatuses, such as typified by printers and copiers to which electro-photographic systems and electrostatic recording systems are applied, employ developer containers, such as a process cartridge having a developer cartridge or a developer accommodating portion, which accommodates developer used in the formation of images (more specifically, in a process of developing electrostatic latent images).

Generally, such a developer container has a cylindrical opening used to be filled with or to store a developer. The developer container is used in a state in which the opening is closed by attaching a predetermined cap (or cover) thereto.

### SUMMARY

According to a first aspect of the present invention, an inner cap, which closes a space portion, which is partly opened and has a cylindrical shape, of a developer container by being brought into a state in which the inner cap is contained in the space portion, and which is caught by a projection portion provided on an inner wall of the space portion, comprising: an outer circumferential portion that has a part to be inserted and fit into an opening portion formed by being surrounded by the projection portion of the space portion; a slip-off preventing projection that is formed at a part located in a downstream side in an insertion direction of the outer circumferential portion to be caught by the projection portion; an insertion stop projection that is formed at a part located in an upstream side in the insertion direction of the outer circumferential portion to be caught by the projection portion; and an insertion front end surface portion that includes a surface in a concave portion dented at a place located inwardly from the outer circumferential portion in a direction opposite to the insertion direction.

### BRIEF DESCRIPTION OF THE DRAWINGS

Exemplary embodiment of the present invention will be described in detail based on the following figures, wherein:

FIG. 1 is a perspective view illustrating a primary part of a developer cartridge according to an embodiment;

FIG. 2 is a perspective view illustrating the entire developer cartridge according to the embodiment;

FIG. 3 is a cross-sectional view of the developer cartridge, which is taken on line Q1-Q1 shown in FIG. 2;

FIG. 4 is a schematic cross-sectional view of the developer cartridge, which is taken on line Q2-Q2 shown in FIG. 2;

FIG. 5 is an enlarged cross-sectional view illustrating a primary part of the developer cartridge shown in FIG. 3;

FIG. 6 is a cross-sectional view illustrating a state in which a cap is removed from a container body shown in FIG. 5;

FIG. 7 is a perspective view illustrating a state of the developer cartridge, which is taken from a front side (i.e., the side of an insertion front end surface) of the inner cap;

FIG. 8 is a perspective view illustrating a state of the developer cartridge, which is taken from a rear side (i.e., the side of an insertion rear end surface) of the inner cap;

FIG. 9 illustrates a side view of the inner cap, and also illustrates a cross-sectional view thereof taken along line Q3-Q3 shown in FIG. 7;

FIGS. 10A and 10B are views illustrating the insertion front end surface of the inner cap, and the insertion rear end surface of the inner cap, respectively;

FIG. 11 is an enlarged cross-sectional view illustrating the configuration of a primary part of the inner cap;

FIG. 12 is a cross-sectional explanatory view illustrating a state in which the inner cap is inserted;

FIG. 13 is a cross-sectional explanatory view illustrating an operating condition in which the inner cap is removed;

FIG. 14 is an explanatory view illustrating an operation of filling a developer in the developer cartridge, and an operation of closing the inner cap;

FIG. 15 is an explanatory view illustrating another example of the configuration of the inner cap, which is taken from an upstream side in a direction in which the inner cap is inserted,

FIG. 16 is a cross-sectional view illustrating another example of the configuration of the inner cap; and

FIG. 17 is an explanatory view illustrating an operation of filling a developer in a developer cartridge having another example of the configuration, and also illustrating an operation of closing the inner cap while the operation of filling a developer is performed.

### DETAILED DESCRIPTION

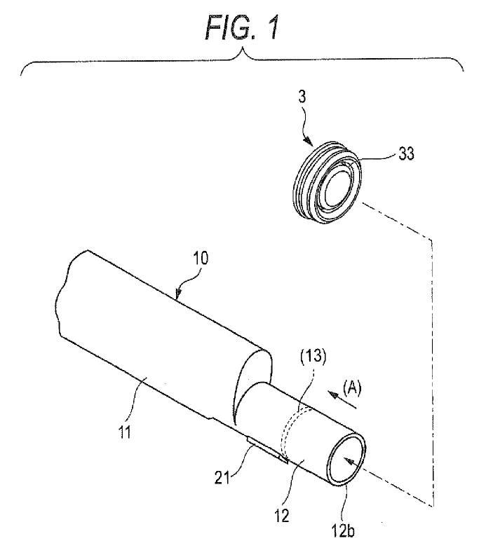

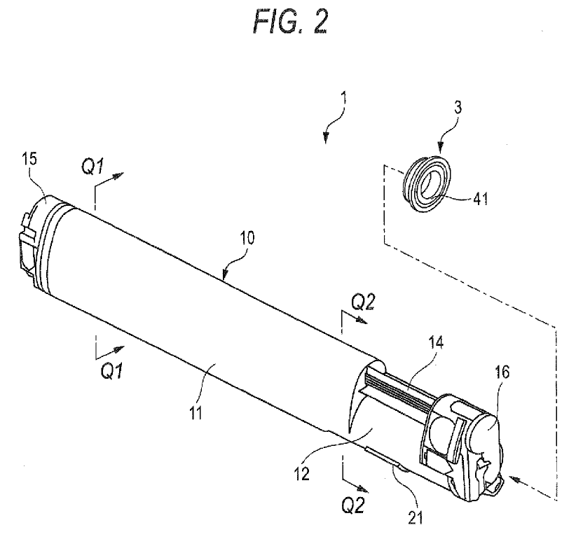

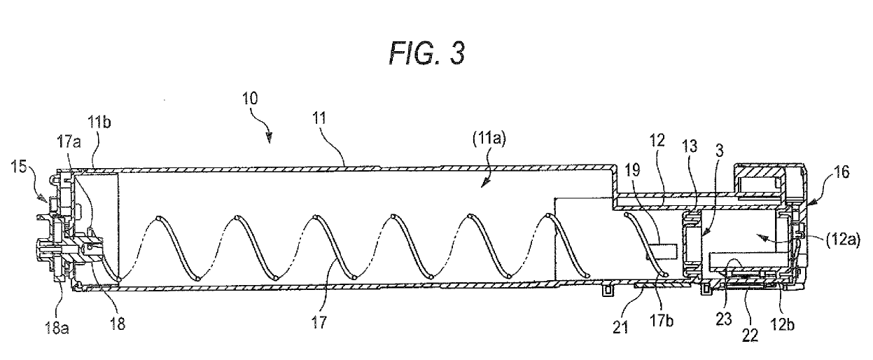

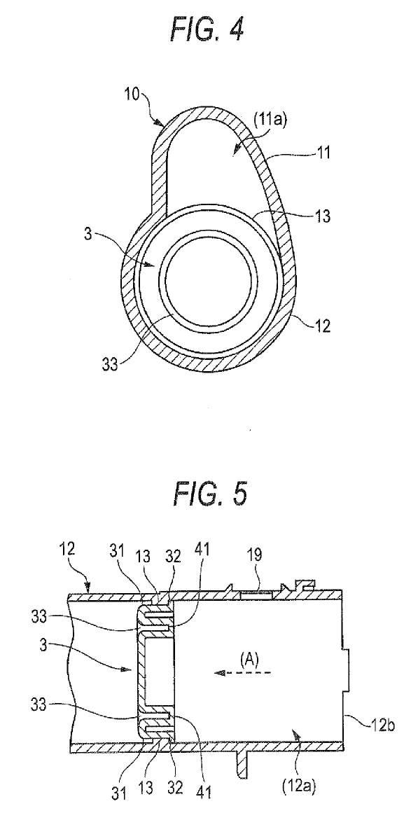

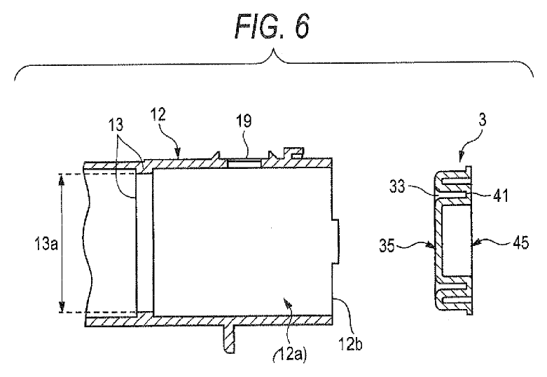

FIGS. 1 to 6 illustrate a developer cartridge (or container) according to an embodiment of the invention. FIG. 1 is a perspective view illustrating a primary part of a developer cartridge according to an embodiment. FIG. 2 is a perspective view illustrating the entire developer cartridge according to the embodiment. FIG. 3 is a cross-sectional view of the developer cartridge, which is taken on line Q1-Q1 shown in FIG. 2. FIG. 4 is a schematic cross-sectional view of the developer cartridge, which is taken on line Q2-Q2 shown in FIG. 2. FIG. 5 is an enlarged cross-sectional view illustrating a primary part of the developer cartridge shown in FIG. 3. FIG. 6 is a cross-sectional view illustrating a state in which a cap is removed from a container body shown in FIG. 5.

### (Fundamental Configuration of the Entire Developer Cartridge)

A developer cartridge 1 has a cylindrical container body 10 opened at both end portions. The container body 10 mainly includes an elliptic tube portion 11 having a cylindrical space portion 11a, whose cross-section is elliptically shaped by partly outwardly expanding a circle to thereby deform a circle, and also includes a circular cylindrical portion 12 having a cross-sectionally circularly-shaped cylindrical space portion 12a provided at one of the sides of the elliptic tube portion 11.

A cross-sectionally rectangularly-shaped annular rib 13 is formed on an inner wall part at a substantially midpoint of the cylindrical portion 12 to protrude at a certain height along the circumference of the inner wall. In the developer cartridge 1, a space portion provided at the side of the elliptic tube portion 11 to extend from the rib 13 serving as a boundary is used as a developer container portion accommodating new developer to be replenished to a developing unit of an image forming apparatus. On the other hand, a space portion provided at the side of the cylindrical portion 12 to extend from the rib 13 serving as the boundary is used as a developer collection portion that accommodates developer connected from, for example, the developing unit. For example, a gripe 14 is formed on the outer surface of the cylindrical portion 12, as circumstances demand.

An outer cap 15 is attached to the developer cartridge 1 to close an opening portion 11b of the elliptic tube portion 11. Also, an outer cap 16 is attached thereto to close an opening portion 12b of the cylindrical portion 12. In the developer cartridge 1, an inner cap 3 is attached to the rib 13 of the cylindrical portion 12. An opening portion (a space designated by reference character 13a in FIG. 6) formed by being surrounded by the rib 13 is closed by the inner cap 3. When attached, the inner cap 3 functions as a partition member to partition the developer container portion and the developer collection portion.

A developer agitation conveyance member 17 adapted to rotate within a range from the position at the side of the opening portion 11b to the position at the front side of the inner cap 3 in the cylindrical portion 12 is installed in the elliptic tube portion 11. The developer agitation conveyance member 17 is, for example, a spiral agitator produced by spirally bending a wire member. An end portion 17a (at the side of the opening portion 11b of the elliptic tube portion 11) of the developer agitation conveyance member 17 is attached to a rotating drive shaft 18 rotatably supported by the outer cap 15. The other end portion 17b thereof is provided to be freely rotatable in a cylindrical space of the cylindrical portion 12 at the front side position of the inner cap 3. A gear (or thread) 18 to be meshed with a drive gear (not shown), which is provided at a mounting portion to receive motive power when the developer cartridge 1 is mounted in the mounting portion of the image forming apparatus, is formed at a part located outside the outer cap 15 of the rotating drive shaft 18.

The developer accommodated in the developer container including the elliptic tube portion 11 is agitated and sent little by little toward a developer discharge port 19 provided at the front part of the inner cap 3 of the cylindrical portion 12.by rotating the developer agitation conveyance member 17. A sliding shutter 21 adapted to open and close the developer discharge port 19 in synchronization with an operation of mounting and demounting the developer cartridge is attached to the outside of the cylindrical portion 12.

A developer intake port 22, from which collected developer is taken in, is formed in an area at the side of the opening portion 12b of the cylindrical portion 12. An opening/closing member 23 used to open and close the developer intake portion 22 from the inside of the cylindrical portion 12 according to circumstances is mounted in the outer cap 16.

### (Configuration of Inner Cap)

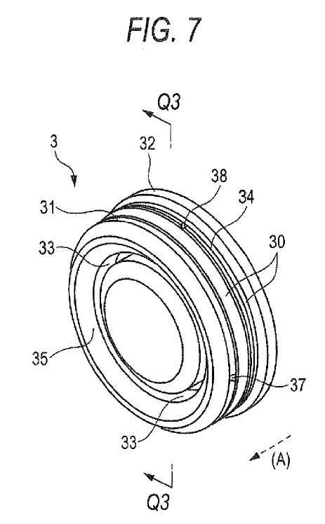

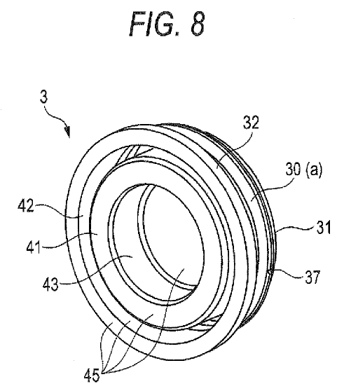

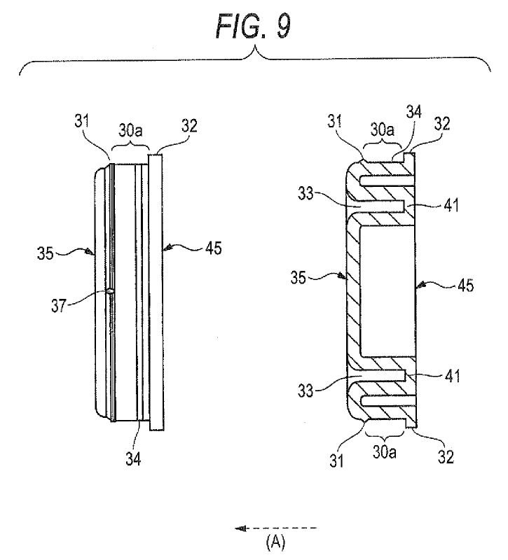

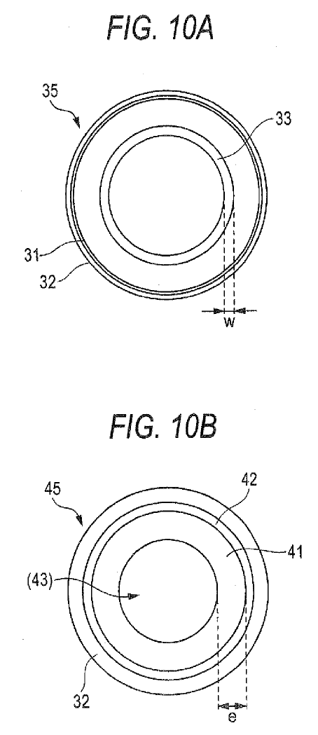

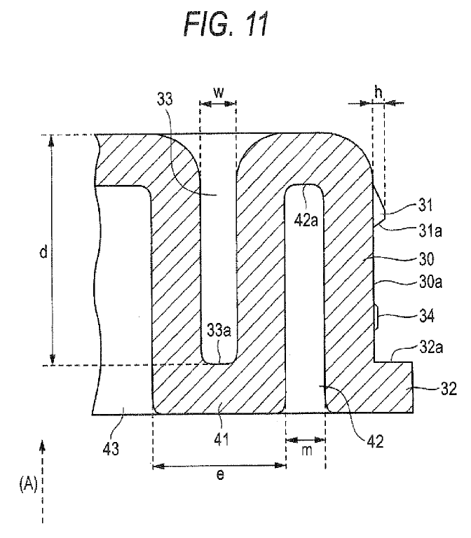

As illustrated in FIGS. 7 to 10, the entire inner cap 3 is shaped substantially like a disk, corresponding to the inner space 12a of the cylindrical portion 12 of the container body 10. Incidentally, FIG. 7 is a perspective view illustrating a state of the developer cartridge, which is taken from a front side of the inner cap. FIG. 8 is a perspective view illustrating a state of the developer cartridge, which is taken from a rear side of the inner cap. FIG. 9 illustrates a side view of the inner cap, and also illustrates a cross-sectional view thereof taken along line Q3-Q3 shown in FIG. 7. FIGS. 10A and 10B are views illustrating the insertion front end surface of the inner cap, and the insertion rear end surface of the inner cap, respectively.

The inner cap 3 includes at least a cylindrical outer circumferential portion 30 to be inserted and fit into a circular opening portion 13b formed by the rib 13 of the cylindrical portion 12 of the container body 10, a slip-off preventing projection 31 formed like an annual ring to be caught in the rib 13 in the downstream side in the insertion direction (A) of the outer circumferential portion 30, an insertion stop projection 32 formed at an upstream side in the insertion direction (A) of the outer circumferential portion 30 to project like a flange and to be caught in the rib 13, an insertion front end surface portion 35 constituted by a surface in which a concave portion 33 dented in a direction opposite to the insertion direction (A) at an inner position from the outer circumferential portion 30, and an insertion rear end surface portion 45 that is opposed to a surface portion opposite to the insertion front end surface portion 35 and that is constituted by a surface, in which a convex portion 41 protruding in a direction opposite to the insertion direction (A).

The outer circumferential portion 30 is formed like a cylindrical surface, whose outside diameter is lightly smaller than an inside diameter of a circular opening portion 13a constituted by the rib 13, so that the fitting portion 30a is opposed to and close to the circumferential surface of the rib 13 upon completion of mounting the inner cap 3. A seal projection 34 in close relation with the circumferential surface of the rib 13 upon completion of mounting the inner cap 3 is formed over the entire outer circumferential surface of the fitting portion 30a.

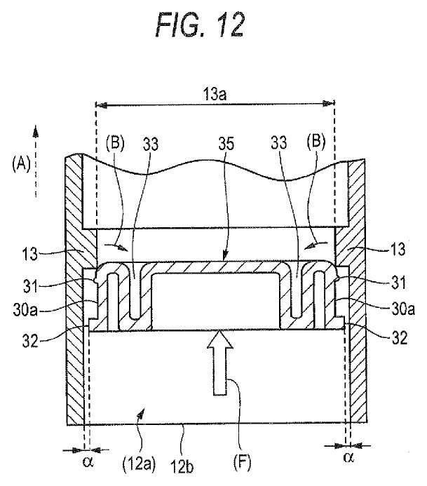

As illustrated in FIGS. 11 and 12, the slip-off preventing projection 31 has a maximum projection part having an outside diameter slightly larger than the inside diameter of a circular opening portion 13a of the rib 13 (incidentally, slightly smaller than the inside diameter of the cylindrical space portion 12a of the cylindrical portion 12). The slip-off projection 31 is formed to have a tapered surface or an R-surface so that the downstream side part in the insertion direction A is tapered off in the insertion direction A. The slip-off projection 31 is formed like a catching portion in which a part 31a provided in the upstream side in the insertion direction A can be caught by touching the rib 13.

As illustrated in FIGS. 11 and 12, the slip-off preventing projection 32 is formed like an annular flange having an outside diameter which is larger than an inside diameter of the circular opening portion 13a of the rib 13 and is smaller than the inside diameter of the cylindrical portion 12a. Consequently, when the inner cap 3 is put into the cylindrical space portion 12a of the cylindrical portion 12, a small gap a (see FIG. 12) is obtained between the insertion stop projection 32 (the outermost portion) and the inner wall of the cylindrical space portion 12a. The insertion stop projection 32 is formed so that the part 32a provided at the upstream side in the insertion direction (A) thereof serves as a catching portion that can be brought into contact with and caught in the rib 13.

As illustrated in FIGS. 7 and 10, the concave portion 33 of the insertion front end surface portion 35 is formed as a concentric circular ring-like groove following the visible outline (circle in this case), which is viewed from the downstream side in the insertion direction (A) of (the outer circumferential portion 30 of) the inner cap. The circular ring-like concave portion 33 is formed into a single continuous shape without interruption.

The circular-ring-like concave portion 33 has a shape deeply dented in parallel to the outer circumferential portion 30 (that is, in a direction substantially parallel to the insertion direction A). The concave portion 33 is formed to have a depth d at which the bottom portion 33a thereof reaches (the catching portion 32a) of the insertion stop projection 32. As illustrated in FIG. 11, the concave portion 33 is set so that the at least the groove width w is larger than the projection height h. With the above configuration, when the inner cap 3 is inserted into and is passed through the circuit opening portion 13a of the rib 13, the outer circumferential portion 30 including the slip-off preventing projection 31 is adapted to be more easily elastically deformed to be inclined to the central portion of the insertion front end surface portion 35.

A convex portion 41 of the insertion rear end surface portion 45 is formed at a same position corresponding to the concave portion 33 of the insertion front end surface portion 35. Also, the convex portion 41 is formed as a convex portion having a single continuous eccentric circular ring shape following the visible line (or circle) of the outer circumferential portion 30. The circular convex portion 41 is a convex portion formed at a place shifted from the central portion of the insertion rear end surface portion 45.

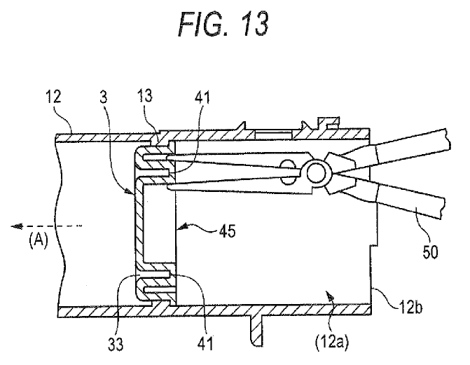

As shown in a cross-sectional view illustrated in FIG. 9, the convex portion 41 of the present embodiment has a structure in which the concave portion 33 of the insertion front end surface portion 35 simultaneously constitutes a convex portion (like two sides of the same coin). Thus, as illustrated in FIGS. 8 to 10, the convex portion 41 forms a first concave portion 42 constituting a convex portion 42 having a circular ring shape between the outer circumferential portion 30 and the convex portion 41. On the other hand, the convex portion 41 is constituted so that a second concave portion 43 constituting a convex portion is formed at a part opposite to the outer circumferential portion 30. Especially, the first concave portion 42 constituting a convex portion is formed at a depth at which the bottom portion 42a reaches the slip-off preventing projection 31, as illustrated in FIG. 11. The convex portion 41 is formed so that the width e is set at a value at which the convex portion 41 can be grabbed by using the grabbing means (see FIG. 13), such as a general grabber. The first concave portion 42 constituting the convex portion is set so that the width m thereof is equal to the width w of the concave portion 33.

Additionally, as illustrated in FIG. 7, slightly dented air vent grooves 37 and 38 are formed the slip-off preventing projection 31 of the insertion front end surface portion 35 and the seal projection 34 of the outer circumferential portion, respectively. Especially, the air vent grooves 37 to be formed at the two places are formed at places shifted in the direction of the circumferential surface of the outer circumferential portion 30, from the viewpoint of preventing leakage of developer passing through the groove.

The inner cap 3 of such a configuration can be manufactured by injection molding using a synthetic resin, such as polyethylene. In this case, as illustrated in FIG. 9, parts respectively constituting a third outer circumferential portion 30, a concave portion 33, and a convex portion 41 are formed so that the thicknesses of these parts are substantially equal to one another (except the projections 31, 32, and 34). Preferably, a synthetic resin used to form the inner cap 3 is of the kind selected so that after molding, the outer circumferential portion 30 including the slip-off preventing projection 31 has a characteristic, according to which the outer circumferential portion 30 is liable to elastically deform, when passed through the circuit space portion 13a of the rib 13.

### (Operation of Closing Developer Cartridge with Inner Cap)

When the cylindrical portion 12 of the developer cartridge 1 is closed by the inner cap 3, as illustrated in FIGS. 1 and 6, first, the inner cap 3 is inserted from the opening portion 12b of the cylindrical portion 12 into the cylindrical space portion 12a to have a posture in which the insertion front end surface portion 35 is directed in the insertion direction A.

Next, as illustrated in FIG. 12, a pushing force F is applied from the insertion rear end surface portion 45 in the insertion direction A so that the insertion front end portion 35 of the inner cap 3 and the outer circumferential portion 30 are inserted into the circular opening portion 13a constituted by the rib 13 of the cylindrical space portion 12.

The inner cap 30 is inserted at that time so that the slip-off preventing projection 31 of the outer circumferential portion 30 passes through the opening portion 13a of the rib 13 and protrudes to the opposite side, and that the insertion stop projection 32 (or the catching portion 32a) of the outer circumferential portion 30 bumps into the rib 13.

When inserted, the slip-off preventing projection 31 passes through the circular opening portion 13a of the rib 13, which is narrower than the maximum outside diameter portion. However, as illustrated in FIG. 12, the outer circumferential portion 30 including the slip-off projection 31 becomes easily elastically deformed to be inclined to the side of the central portion of the front end surface portion 35 (in the direction of an arrow B in this figure) because the gap due to the concave portion 33 is present in the insertion front end surface portion 35. Consequently, the insertion and passing of the outer circumferential portion 30 are relatively easy.

Also, when the inner cap 3 is inserted so that the insertion stop projection 32 bumps into the rib 13, the fitting portion 30a of the outer circumferential portion 30 of the inner cap 3 is fit into the space portion 13a of the rib 13 (the seal projection 34 is put into close contact therewith), as illustrated in FIG. 5. Consequently, the inner cap 3 is caught in the rib 13 by being into a state in which the inner cap 3 is completely contained in the space portion 12a of the cylindrical portion 12. Thus, the space portion 12a of the cylindrical portion 12 in the container body 10 of the developer cartridge 1 is closed by the inner cap 3.

### (Operation of Removing Inner Cap)

Meanwhile, when the inner cap is removed after the space portion 12a of the cylindrical portion 12 in the container body 10 of the developer cartridge 1 is closed with the inner cap 3, first, as illustrated in FIG. 13, a general tool 50, such as a needle-nose plier, is inserted therein from the opening portion 12b of the cylindrical portion 12. Thus, the convex portion 41 of the insertion rear end surface portion 45 of the inner cap 3 is pinched and grabbed. At that time, the convex portion 41 has a single continuous shape. Accordingly, the position, at which the convex portion 41 is grabbed, is not limited to a specific position. Thus, the inner cap is easy to use.

Subsequently, the general grabber 50 is pulled in a direction opposite to the insertion direction. Consequently, the inner cap 3 is released from a caught state by passing the insertion front end surface portion 35 and the outer circumferential portion 30 through the circular opening portion 13a constituted by the rib 13 of the cylindrical space portion 12. Thus, although the inner cap 3 is completely contained in the space portion 12a of the cylindrical portion 12, the inner cap 3 is easily removed from the space portion 12a.

At removing of the inner cap, when the outer circumferential portion 30 including the slip-off preventing projection 31 is pulled out through the rib 13, the outer circumferential portion 30 becomes easily elastically deformed to be inclined to a side in which a space of the concave portion 33 of the insertion front end surface portion 35 is present. The pressure, at which the convex portion 41 of the insertion rear end surface portion 45 is pinched and grabbed by a general grabber 50, is applied to the outer circumferential portion 30 including the slip-off preventing projection 31, so that the elastic deformation is considered to be promoted. Additionally, it is also supposed that the convex portion 41 is formed at a place shifted from the central portion of the insertion rear end surface portion 45, that because the convex portion 41 positioned at such a place is pinched and pulled, an action according to the principle of leverage operates, and that the outer circumferential portion 30 including the slip-off preventing projection 31 of the inner cap 3 can be pulled out from the rib 13. Incidentally, the removed inner cap 3 can be reused together with the container body 10.

### (Operation of Filling Developer in Developer Cartridge and Operation of Closing Developer Cartridge with Inner Cap)

Hereinafter, an operation of filling developer in the developer cartridge 1 and an operation of closing the developer cartridge 1 with the inner cap 3 are described.

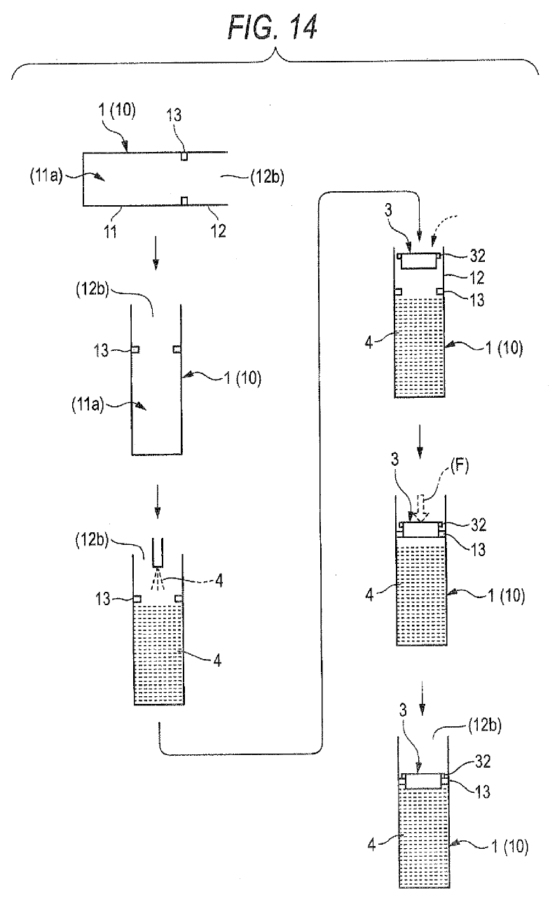

First, as illustrated in FIG. 14, the developer cartridge 1 is configured so that the cylindrical container body 10 is opened at an end portion (an opening portion 12b) at the side of the cylindrical portion 12. Thus, the developer cartridge 1 is held in a standing posture in which the opening portion 12b is placed at an upper side. Subsequently, the developer 4 is poured into and is filled in the space portion 11b of the elliptic tube portion from the opening portion 12b.

Next, the inner cap 3 is put into from the opening portion 12b into the container body 10 filled with the developer 4. At that time, the insertion stop projection 32 of the inner cap 3 is formed to have a outside diameter smaller than an inside diameter of the space portion of the cylindrical portion 12. Thus, a space α (see FIG. 12) is present between the projection 32 and the inner wall of the space portion. Consequently, an operation of putting the inner cap 3 into the space portion of the cylindrical portion 12 can physically smoothly be performed due to the presence of the space α. The infiltration of the inner cap 3 causes redundant air, which is present in the container body 10, to move toward the exterior of the container body 10 through the space α. Thus, the operation of putting the inner cap 3 into the space portion can smoothly be achieved. Consequently, the inner cap 3 is smoothly moved to a part at which the rib 13 is provided.

Subsequently, the inner cap 3 having been pushed to a certain part of the rib 13 is pushed in the insertion direction from the insertion rear end surface portion 45 by a predetermined pushing force F. Thus, as above-described, the inner cap 3 is caught by the rib 13 to thereby close the space portion of the cylindrical portion 12. After the closing of the inner cap 3 is finished, the outer cap 16 is attached to the opening portion 12b of the cylindrical portion 12.

In the developer cartridge 1, the air vent grooves 37 and 38 are provided in the inner cap 3. Thus, when the space portion of the cylindrical portion 12 is closed by the inner cap 3, or even when the internal pressure of the space portion 11a of the elliptic tube portion 11, which is filled with the developer 4, is increased later, redundant air is discharged to the space portion of the cylindrical portion 12 through the air vent grooves 37 and 38. Consequently, the following defect can be prevented from occurring. That is, when the developer cartridge 1 filled with the developer is treated, the internal pressure of the space portion 11a of the elliptic tube portion 11 may extremely rise. Thus, a small space may be created between the container body 10 and the inner cap 3 or between the container body 10 and the outer cap 15 due to distortion. Accordingly, a defect may occur. That is, the developer 4 may be externally ejected from the space.

### Other Embodiments

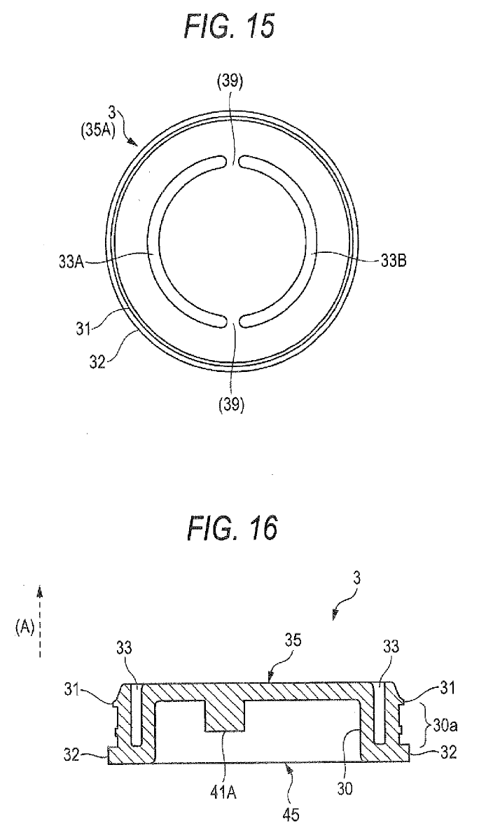

Incidentally, the concave portion 33 on the insertion front end surface portion 35 of the inner cap 3 can have a discontinuous circular-arc-like shape, as illustrated in FIG. 15 (the concave portion 33 is, for example, a combination of a circular-arc-like first concave portion 33A and a circular-arc-like second concave portion 33B).

In this case, at parts (39) between the circular-arc-like first concave portion 33A and the circular-arc-like second concave portion 33B, the insertion front end surface portion 35 is in a connected state in which the concave portion is discontinuous. From the viewpoint of facilitation of occurrence of elastic deformation of the outer circumferential portion 30 including the slip-off preventing projection 31 at the attachment of the inner cap 3 or at the removal of the inner cap 3, the width of each of the parts 39 is as narrow (or small) as possible.

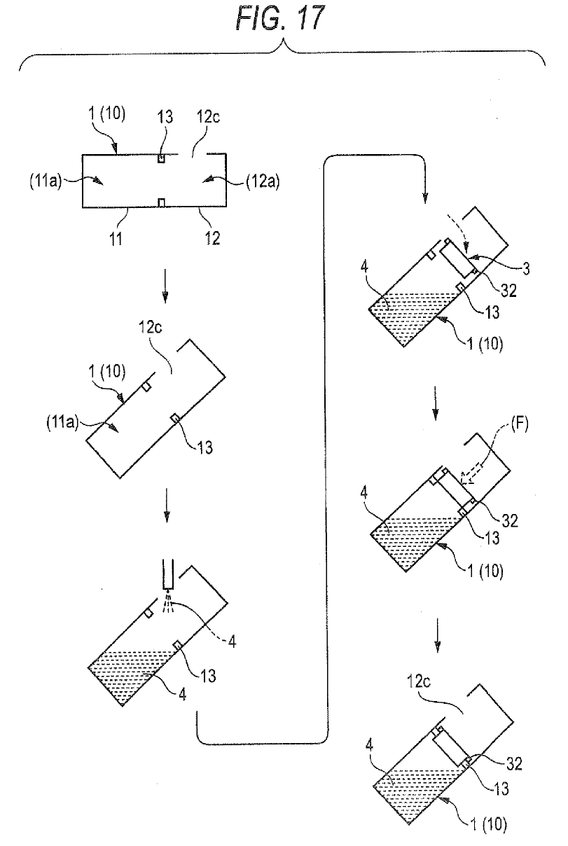

As illustrated in FIG. 16, the inner cap 3 can be formed so that the concave portions 33 of the insertion front end surface portion 35 adjoin each other at a place immediately inwardly from the outer circumferential portion 30. The convex portion 41 of the insertion rear end surface portion 45 can be formed at a place shifted from the central portion of the surface portion 45 to protrude in a direction opposite to the insertion direction A, as illustrated in FIG. 16.

Also, as illustrated in FIG. 17, in a case where the container body 10 of the developer cartridge 1 having an opening portion 12c formed in the cylindrical circumferential surface of the cylindrical portion 12 is used, it is advisable to perform operations of filling the developer carriage with the developer and of closing the carriage with the inner cap as follows.

That is, when the developer cartridge 1 is filled with the developer, the container body 10 of the developer cartridge 1 is held in an inclined posture in which the opening portion 12c is placed at an upper side. Subsequently, the developer cartridge 1 is filled with the developer 4 by pouring the developer 4 from the opening portion 12c into the space portion lib of the elliptic tube portion.

Next, the inner cap 3 is put into the inclined container body 10, which is filled with the developer 4, from the opening portion 12c. Similarly, at that time, the space α (see FIG. 12) is present between the projection 32 and the inner wall of the space portion, because the insertion stop projection 32 of the inner cap 3 is formed to have an outside diameter smaller than the inside diameter of the space portion of the cylindrical portion 12. Consequently, an operation of putting the inner cap 3 into the space portion of the cylindrical portion 12 can smoothly be achieved. Accordingly, the inner cap 3 is smoothly put into a certain part of the rib 13. Subsequently, the inner cap 3 is caught by the rib 13 by pushing the inner cap 3, which has been put into a certain part of the rib 13, in the insertion direction with a predetermined pushing force F from the insertion rear end surface portion 45. Thus, the space portion of the cylindrical portion 12 is closed.

Additionally, the inner cap 3 can be applied to, for example, a process cartridge that is formed by integrally uniting an image holding element, such as a photoreceptor drum, and a developing unit, and that is equipped with a developer accommodating portion which accommodates developer to be supplied to the developing unit. In this case, it is advisable to form a cylindrical filling port from which developer is filled in the developer accommodating portion, and to provide a rib 13 in the cylindrical space portion so that the inner cap is caught by the rib 13 to close the cylindrical space portion having the filling port. Further, the inner cap 3 can be applied to a developer collection container used to collect the developer.

In the foregoing description of the above embodiment, a cap, the entire of which is shaped like a disk, has been exemplified as the inner cap 3. However, the cross-sectional shape of the entire inner cap is not limited thereto. As long as the shape of the inner cap corresponds to the cylindrical space portion to be closed by the inner cap, other shapes may be employed as the shape of the inner cap.

Additionally, the inner cap 3 is effective in a case where the insertion rear end surface 45 (actually, for example, the insertion stop projection 32) is not protruded at all externally from the opening portion 12b of the space portion to be closed. That is, in this case, especially, an operation of removing the inner cap is difficult to perform, because a part to be grabbed is not protruded at all externally from the space portion to be closed. In the inner cap 3, the convex portion 41 is formed on the insertion rear end surface 45. Thus, even in a state in which the inner cap 3 is caught, the removal of the inner cap 3 can be achieved by pinching and grabbing the convex portion 41.

What is claimed is:

1. An inner cap, which closes a space portion, which is partly opened and has a cylindrical shape, of a developer container by being brought into a state in which the inner cap is contained in the space portion, and which is caught by a projection portion provided on an inner wall of the space portion, comprising:
an outer circumferential portion that has a part to be inserted and fit into an opening portion formed by being surrounded by the projection portion of the space portion;
a slip-off preventing projection that is formed at a part located in a downstream side in an insertion direction of the outer circumferential portion to be caught by the projection portion;
an insertion stop projection that is formed at a part located in an upstream side in the insertion direction of the outer circumferential portion to be caught by the projection portion; and
an insertion front end surface portion that includes a surface in a concave portion dented at a place located inwardly from the outer circumferential portion in a direction opposite to the insertion direction.

2. The inner cap as claimed in claim 1, wherein the concave portion comprises a groove formed into a shape following a visible outline of the outer circumferential portion, which is viewed from the downstream side in the insertion direction.

3. The inner cap as claimed in claim 1, wherein the concave portion has a single continuous shape.

4. The inner cap as claimed in claim 1, wherein the concave portion has a depth reaching a position at which the insertion stop projection is formed.

5. The inner cap as claimed in claim 1, wherein the slip-off preventing projection and a part of the outer circumferential portion have air vent grooves.

6. The inner cap as claimed in claim 1, further comprising an insertion rear end surface portion that is opposed to the insertion front end surface portion and that includes a surface on which a convex portion protruding in a direction opposite to the insertion direction is formed.

7. The inner cap as claimed in claim 6, wherein the convex portion of the insertion rear end surface portion is formed at a place shifted from a central portion of the insertion rear end surface portion.

8. The inner cap as claimed in claim 6, wherein the convex portion of the insertion rear end surface portion is formed into a single continuous shape in the insertion rear end surface portion.

9. The inner cap as claimed in claim 6, wherein the convex portion of the insertion rear end surface portion is formed at a same place corresponding to the concave portion of the insertion front end surface portion.

10. The inner cap as claimed in claim 6, wherein the convex portion of the insertion rear end surface portion is constituted by forming a concave portion constituting a convex portion having a depth reaching the slip-off preventing projection between the outer circumferential portion and the convex portion.

11. A developer container having a space portion in which a projection portion is formed on an inner wall thereof, the space portion being partly opened and having a cylindrical shape,
wherein
the space portion is closed by an inner cap according to claim 1.

12. A method for closing a developer container having a space portion, which is partly opened and has a cylindrical shape, with an inner cap according to claim 1,
wherein
putting the inner cap into the space portion;
pushing the inner cap so that the insertion front end surface portion of the inner cap and the outer circumferential portion are inserted into an opening portion formed by being surrounded by the projection portion of the space portion;
inserting the insertion front end surface portion and the outer circumferential portion so that the slip-off preventing projection of the outer circumferential portion penetrates through and protrudes from the opening portion, and that the insertion stop projection bumps into the projection portion; and
closing the space portion by catching the inner cap in the space portion so that the inner cap is contained in the space portion.

13. An inner-cap removing method, which closes a developer container having a space portion, which is partly opened and has a cylindrical shape, with the inner cap according to claim 6, and which removes the inner cap,
wherein
removing the inner cap by pinching and grasping the convex portion of the insertion rear end surface portion of the inner cap caught in the space portion, and by pulling the convex portion in a direction opposite to the insertion direction.
